(19) United States
(12) Patent Application Publication
(10) Pub. No.: US 2009/0055883 A1
(43) Pub. Date: Feb. 26, 2009

(54) BROADCASTING SIGNAL PROCESSING APPARATUS AND CONTROL METHOD THEREOF

(75) Inventor: Chul-mok LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/098,481

(22) Filed: Apr. 7, 2008

(30) Foreign Application Priority Data
Aug. 20, 2007 (KR) 10-2007-0083466

(51) Int. Cl. H04N 7/173

(52) U.S. Cl. 725/105

(57) ABSTRACT

A broadcasting signal processing apparatus, includes: a signal processor which processes a broadcasting signal having an application to provide broadcasting program information; an output unit which outputs the broadcasting program information; and a controller which stores the broadcasting program information of the application according to a user's command, and provides the broadcasting program information corresponding to the selected application through the output unit if the stored application is selected by a user.

### CROSS-REFERENCE TO RELATED APPLICATION

This application claims priority from Korean Patent Application No. 10-2007-0083466, filed on Aug. 20, 2007, in the Korean Intellectual Property Office, the disclosure of which is incorporated herein by reference.

### BACKGROUND OF THE INVENTION

1. Field of the Invention

Apparatuses and methods consistent with the present invention relate to a broadcasting signal processing apparatus and a control method thereof, and more particularly, to a broadcasting signal processing apparatus which stores broadcasting program information and searches the stored broadcasting program information according to user's needs, and a control method thereof.

2. Description of the Related Art

Recently, digital broadcasting has commenced on a full-blown scale, and a broadcasting signal processing apparatus, e.g. a digital TV or a set-top box which receives a digital broadcasting signal has increasingly been used. Most homes now can access the digital broadcasting without difficulty.

The digital broadcasting provides data broadcasting which allows a broadcasting signal processing apparatus to receive applications including various additional information and supplies various information included in the received applications to a user.

The data broadcasting may be classified into independent data broadcasting and synchronized data broadcasting according to supplied information.

The independent data broadcasting supplies information corresponding to an application that is executed regardless of a broadcasting program provided by a channel change, e.g. information such as news, sports, weather, stocks, etc.

The synchronized data broadcasting supplies broadcasting program information which is synchronized with a broadcasting program provided by a channel change. The broadcasting program information may include, e.g. a synopsis, characters, and captured images of the concerned broadcasting program.

The broadcasting signal processing apparatus which supports the synchronized data broadcasting receives a broadcasting signal including an application having the broadcasting program information, and displays the received broadcasting program information to a user if the concerned application is executed to view the broadcasting program.

The executed application ends when the concerned broadcasting program ends.

Recently, the number of broadcasting channels has drastically increased, and accordingly the broadcasting programs are numerous. Also, the types of supplied applications have increased dramatically.

Thus, a user may not recognize the types of supplied applications or may not memorize the application that was executed before.

Moreover, if a user desires to execute the application that was executed before, a user should wait until the broadcasting time of the concerned broadcasting program.

### SUMMARY OF THE INVENTION

Accordingly, it is an aspect of the present invention to provide a broadcasting signal processing apparatus which stores broadcasting program information corresponding to an application that was executed before and searches the broadcasting program information if necessary, and a control method thereof.

Also, it is another aspect of the present invention to provide a broadcasting signal processing apparatus which provides a list of stored applications to be easily searched by a user, and a control method thereof.

Additional aspects of the present invention will be set forth in part in the description which follows and, in part, will be obvious from the description, or may be learned by practice of the present invention.

The foregoing and/or other aspects of the present invention are also achieved by providing a broadcasting signal processing apparatus, comprising: a signal processor which processes a broadcasting signal having an application to provide broadcasting program information; an output unit which outputs the broadcasting program information; and a controller which stores the broadcasting program information of the application according to a user's command, and provides the broadcasting program information corresponding to the selected application through the output unit if the stored application is selected by a user.

The broadcasting program information may comprise at least one of a title of the application, a storage date, channel information, broadcasting information, broadcasting time, a synopsis, characters and a thumb image of the broadcasting program.

The controller may store the broadcasting program information corresponding to the executed application if a user inputs a particular command while the application is executed.

The controller may control the output unit to display a list of the stored applications.

The broadcasting program information may further comprise execution reservation information of the application and the broadcasting program corresponding to the application.

The controller outputs the application and the broadcasting program corresponding to the application on a reservation time corresponding to the stored execution reservation information.

The broadcasting signal processing apparatus may further comprise a user input unit which receives a user's command.

The broadcasting signal processing apparatus may further comprise a storage unit which stores the broadcasting program information therein.

The output unit may comprise a display unit.

The broadcasting signal processing apparatus may further comprise a UI generator which generates at least one UT (user interface) having a menu on the broadcasting program information.

The broadcasting signal processing apparatus may further comprise a broadcasting receiver which receives the broadcasting signal having the application.

The controller may compare the stored broadcasting program information with broadcasting program information received through the broadcasting receiver, and update the stored broadcasting program information based on the comparison result.

The foregoing and/or other aspects of the present invention are also achieved by providing a broadcasting signal processing apparatus, comprising: a signal processor which processes a broadcasting signal having an application to provide broadcasting program information; an output unit which outputs the broadcasting program information; and a controller which receives a user's command to reserve an execution of the application, and provides the broadcasting program information corresponding to the application on a reservation time through the output unit.

The broadcasting signal processing apparatus may further comprise a storage unit, wherein the controller stores the inputted execution reservation information in the storage unit.

The controller may output a broadcasting program corresponding to the application on the reservation time.

The foregoing and/or other aspects of the present invention are also achieved by providing a control method of a broadcasting signal processing apparatus, comprising: executing an application to provide broadcasting program information; storing broadcasting program information of the application according to a user's command; and providing the broadcasting program information corresponding to the selected application if the stored application is selected by a user.

The broadcasting program information may comprise at least one of a title of the application, a storage date, channel information, broadcasting information, broadcasting time, a synopsis, characters, and a thumb image of the broadcasting program.

The control method may further comprise displaying a list of the stored applications before providing the broadcasting program information.

The broadcasting program information may further comprise execution reservation information of the application and the broadcasting program corresponding to the application.

The control method may further comprise changing to a channel providing a broadcasting program corresponding to the application on a reservation time corresponding to the stored execution reservation information, and executing the application.

The control method may further comprise generating at least one menu having a list of the applications having the stored broadcasting program information.

The control method may further comprise receiving a broadcasting signal having the application having the stored broadcasting program information; and comparing the stored broadcasting program information with broadcasting program information included in the received broadcasting signal, and updating the stored broadcasting program information based on the comparison result.

The foregoing and/or other aspects of the present invention are also achieved by providing a control method of a broadcasting signal processing apparatus, comprising: executing an application to provide broadcasting program information; receiving a user's command to reserve an execution of the application; and providing broadcasting program information corresponding to the application on a reservation time.

The control method may further comprise storing information on the inputted execution reservation.

The providing the broadcasting program information may comprise outputting a broadcasting program corresponding to the application on the reservation time.

### BRIEF DESCRIPTION OF THE DRAWINGS

The above and/or other aspects of the present invention will become apparent and more readily appreciated from the following description of the embodiments, taken in conjunction with the accompanying drawings of which:

FIGS. 1 and 2 are block diagrams of a broadcasting signal processing apparatus according to an exemplary embodiment of the present invention;

FIG. 3 illustrates an example of searching a bookmarked application according to the exemplary embodiment of the present invention; and

FIGS. 4 to 8 are flowcharts to describe a control method of the broadcasting signal processing apparatus according to the exemplary embodiment of the present invention.

### DETAILED DESCRIPTION OF EXEMPLARY EMBODIMENT

Hereinafter, exemplary embodiments of the present invention will be described with reference to accompanying drawings, wherein like numerals refer to like elements and repetitive descriptions will be avoided as necessary.

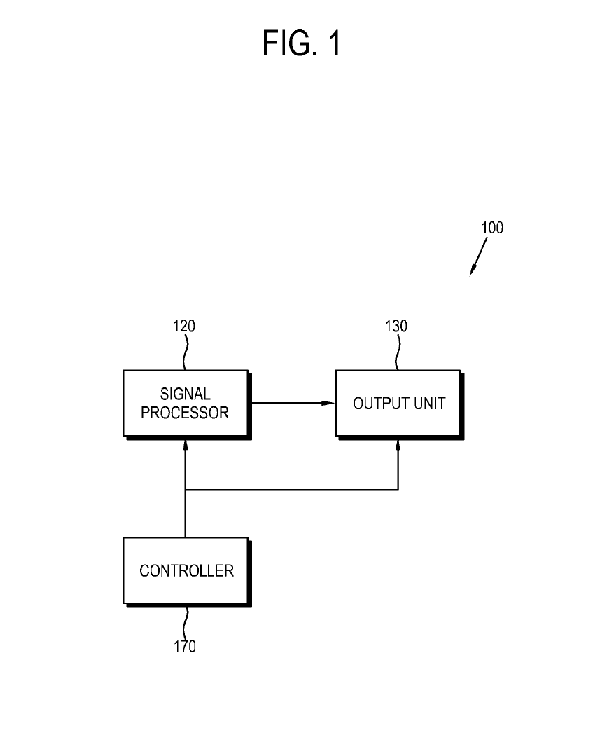

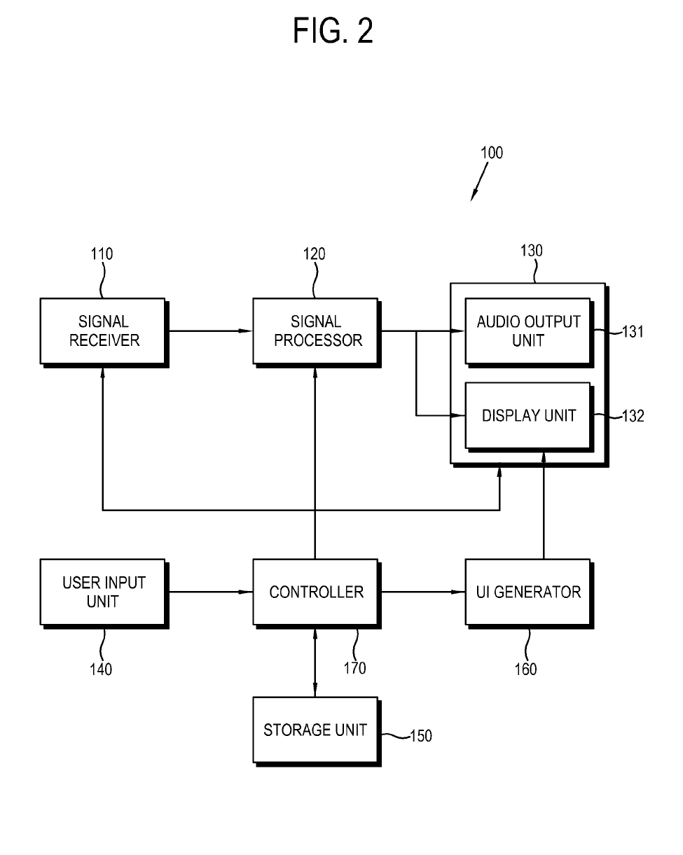

FIGS. 1 and 2 are block diagrams of a broadcasting signal processing apparatus 100 according to an exemplary embodiment of the present invention.

The broadcasting signal processing apparatus 100 may include a TV or a set-top box. The broadcasting signal processing apparatus 100 receives a broadcasting signal from a broadcasting station, and processes the broadcasting signal to display an image based on the received broadcasting signal.

The broadcasting signal includes an application to provide various additional information such as data broadcasting. The application may include Java application which is defined by a specification such as OCAP (open cable application platform), ACAP (advanced common application platform) and MHP (multimedia home platform) of digital TV broadcasting.

As shown in FIGS. 1 and 2, the broadcasting signal processing apparatus 100 includes a signal receiver 110, a signal processor 120, an output unit 130, a user input unit 140, a storage unit 150, a UT generator 160 and a controller 170.

The signal receiver 110 tunes to a frequency corresponding to one of a plurality of channels and receives a broadcasting signal according to a control of the controller 170. The broadcasting signal may include at least one application to supply various additional information.

The additional information of the application may include independent data which are not directly related to a broadcasting program, as well as synchronized data providing broadcasting program information.

More specifically, the broadcasting program information of the synchronized data includes channel information, a synopsis, characters, captured images and execution reservation information of the concerned broadcasting program. The independent data may include news, sports, weather, etc. which are not related to the broadcasting program.

The signal processor 120 divides the received broadcasting signal into a video signal, an audio signal and an application supplying various additional information.

More specifically, the signal processor 120 demodulates and decodes the broadcasting signal received by the signal receiver 110 to display the broadcasting signal including broadcasting program information according to a control of the controller 170.

The output unit 130 outputs the video signal, the audio signal and the application processed by the signal processor 130.

The output unit 130 may include an audio output unit 131 and a display unit 132.

The audio output unit 131 may include a speaker, and outputs the audio signal decoded by the signal processor 120.

The display unit 132 may include various types of display modules including a digital light processing (DLP) display, a liquid crystal display (LCD) and a plasma display panel (PDP). The video signal which is processed by the signal processor 120 is outputted after a vertical frequency, resolution and picture ratio are converted according to an output standard of the display unit 132.

The various additional information included in the application is divided by the signal processor 120, and then outputted through the audio output unit 131 and the display unit 132.

The user input unit 140 receives a user's input to store and search the broadcasting program information.

The user input unit 140 may include a remote controller having at least one button as a hot key or a control panel provided in the broadcasting signal processing apparatus 100. The controller 170 may determine that a user's command is inputted if the button of the remote controller or the control panel is pressed.

The storage unit 150 stores the broadcasting program information therein corresponding to the received application.

The UT generator 160 generates at least one UT (user interface) including a menu on the broadcasting program information stored in the storage unit 150.

The generated UT is displayed on the display unit 132.

The controller 170 stores the broadcasting program information of the application in the storage unit 150 according to a user's command inputted through the user input unit 140. If the application having the stored broadcasting program information is selected by a user, the controller 170 outputs the broadcasting program information corresponding to the selected application through the output unit 130.

If a user inputs a particular command while the application is executed to provide the broadcasting program information, the controller 170 stores the broadcasting program information corresponding to the executed application.

For example, a user may execute the application to search the broadcasting program information corresponding to a broadcasting program while viewing the broadcasting program received through a particular channel.

Then, the controller 170 controls the UT generator 160 to generate at least one UT including a menu on various information such as a broadcasting channel, broadcasting time, a synopsis, captured images of the broadcasting program corresponding to the executed application, and outputs the generated UT through the output unit 130.

A user recognizes the outputted broadcasting program information, and stores (hereinafter, to be called “bookmarks” too) the broadcasting program information corresponding to the concerned application in the storage unit 150 through the user input unit 140.

Here, the controller 170 may set a predetermined name of the bookmarked application by combining the channel information and a program title or may receive the name of the concerned application from a user through the user input unit 140.

The controller 170 may receive information whether to reserve an execution of the bookmarked application from a user, and may store the inputted execution reservation information with the broadcasting program information.

The controller 170 may store the broadcasting program information corresponding to the bookmarked application as a predetermined table in the storage unit 150, and may output the list of the bookmarked applications if a user inputs a command to search the bookmarked applications.

More specifically, the controller 170 searches the bookmarked application through the user input unit 140, controls the UT generator 160 to generate the list, and outputs the generated list through the output unit 130.

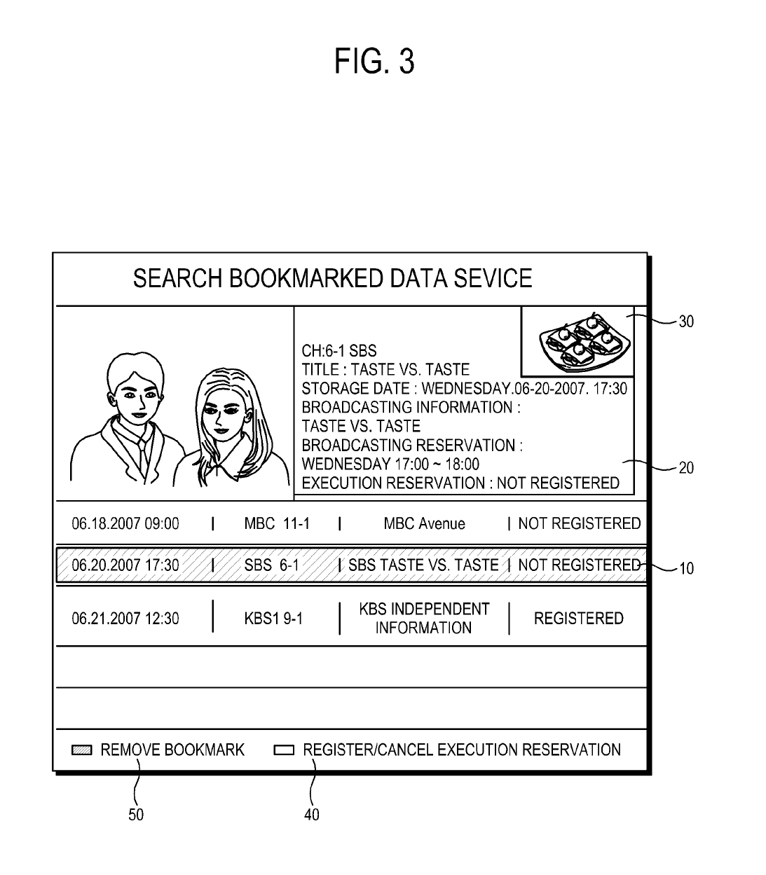

FIG. 3 illustrates an example of searching the bookmarked application according to the exemplary embodiment of the present invention.

If a command is inputted to search the bookmarked application by the user input unit 140, the controller 170 outputs the list of the bookmarked applications through the output unit 130 as shown in FIG. 3.

If a user selects an application 10 to search the broadcasting program information through the user input unit 140, the controller 170 outputs broadcasting program information 20 corresponding to the selected application 10 on a sub screen of the display unit 132.

If the selected application includes an audio signal, the audio signal may be outputted by the audio output unit 131.

The broadcasting program information 20 outputted to the sub screen includes a title of the bookmarked application, storage date, channel information, broadcasting information (e.g., a synopsis and characters), broadcasting time, execution reservation and a thumb image 30 (e.g. captured images of the broadcasting program) of the bookmarked application.

The controller 170 controls the UT generator 160 and the display unit 132 to generate and output a menu 40 to register or cancel the execution reservation and a menu 50 to remove the bookmark by receiving information on the execution reservation of the bookmarked application through the user input unit 140.

Thus, a user may bookmark the application which was executed before, and search the desired information if necessary.

The controller 170 continuously monitors the reservation time of the application having the registered execution among the bookmarked applications stored in the storage unit 150.

The registered execution refers to a registration of the application to be automatically executed so that a user views the broadcasting program corresponding to the application. The broadcasting program may include series programs which are broadcast on the particular time on a particular day. If the execution is registered, a channel is automatically changed to the broadcasting channel of the broadcasting program on the registered execution time.

If the execution reservation time of the particular application comes up, the controller 170 controls the output unit 130 to output the concerned broadcasting program.

More specifically, the controller 170 may determine whether a broadcasting program outputted by the broadcasting signal processing apparatus 100 on the execution reservation time is the broadcasting program having the registered execution.

If a broadcasting program of another channel is executed instead of the broadcasting program having the registered execution, the controller 170 changes to the broadcasting channel supplying the broadcasting program having the registered execution.

The controller 170 may receive a user's input through the user input unit 140 whether to change the broadcasting channel, and change the broadcasting channel based on the input result.

If the broadcasting signal processing apparatus 100 does not operate on the reservation time, the controller 170 may control to supply operating power and tune to the concerned channel.

Thus, if the broadcasting time of the desired broadcasting program comes up, a user may view the broadcasting program.

If the broadcasting program is outputted, the controller 170 searches the application stored in the storage unit 150 and automatically executes the application corresponding to the broadcasting program to provide a user with the broadcasting program information through the output unit 130.

The user's command to register the execution is inputted by a particular button of the user input unit 140, and may be independently inputted from a user's command to bookmark the application.

The controller 170 may compare the broadcasting program information included in the application continuously received through the signal receiver 110 with the broadcasting program information stored in the storage unit 150.

For example, the signal receiver 110 may receive an application including broadcasting program information to be broadcast in ten hours from the current time when the broadcasting signal processing apparatus 100 is installed initially. Later, the signal receiver 110 may receive an application corresponding to a broadcasting program to be broadcast one hour later.

The controller 170 may update the broadcasting program information stored in the storage unit 150 with latest information, based on the comparison result of the continuously-received broadcasting program information and the prestored broadcasting program information.

Thus, even if the broadcasting program has a change, e.g. even if the broadcasting time of the program is changed, the controller 170 may search and reserve the execution of the latest information.

The controller 170 may update the broadcasting program information with the latest information or may maintain the existing information according to user's selection. Even if the broadcasting program information is updated, the existing information may be stored in the storage unit 150 to be searched by a user at any time.

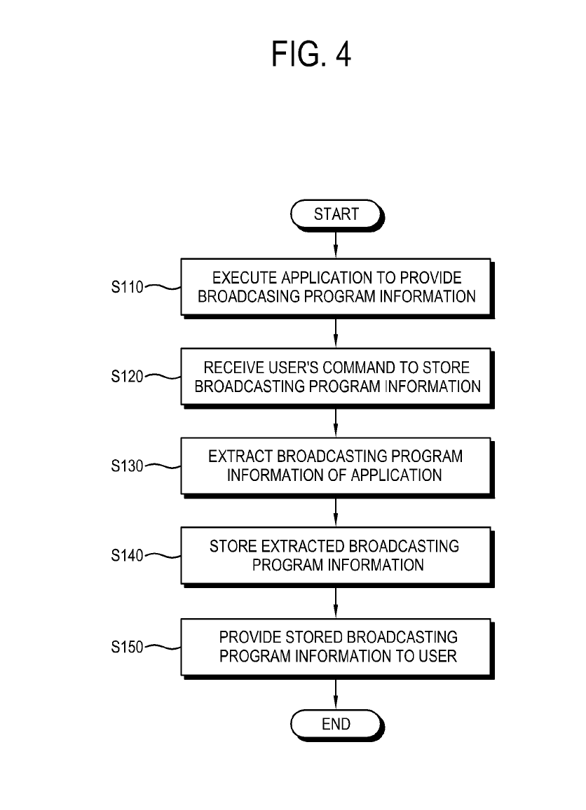

Hereinafter, a control method of the broadcasting signal processing apparatus 100 having the foregoing configuration will be described with reference to FIGS. 4 to 8.

As shown in FIG. 4, the controller 170 executes the application to receive the broadcasting program information while the broadcasting program is played (S110).

The controller 170 may receive an input from a user to store, i.e. to bookmark the broadcasting program information corresponding to the executed application (S120).

The controller 170 extracts the broadcasting program information of the application according to the user's command inputted at operation S120 (S130).

The controller 170 may bookmark the extracted broadcasting program information in the storage unit 150 (S140).

The broadcasting program information stored at operation S140 is provided to a user through the output unit 130 (S150).

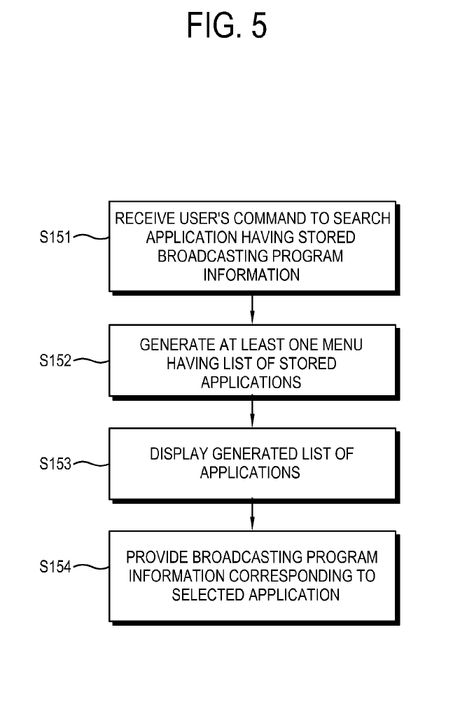

As shown in FIG. 5, at operation S150, the controller 170 may receive an input from a user to search the bookmarked application, i.e. the application having the broadcasting program information stored in the storage unit 150 (S151).

Then, the controller 170 controls the UT generator 160 to generate a menu having the list of the applications bookmarked at operation S151 (S152).

The controller 170 displays the list generated at operation S152, through the output unit 130 (S153).

If a user selects an application from the list of the applications displayed at operation S152, the controller 170 provides the broadcasting program information corresponding to the selected application to a user through the output unit 130 (S154).

The broadcasting program information stored at operation S140 may further include information as to whether to reserve the execution of the concerned broadcasting program.

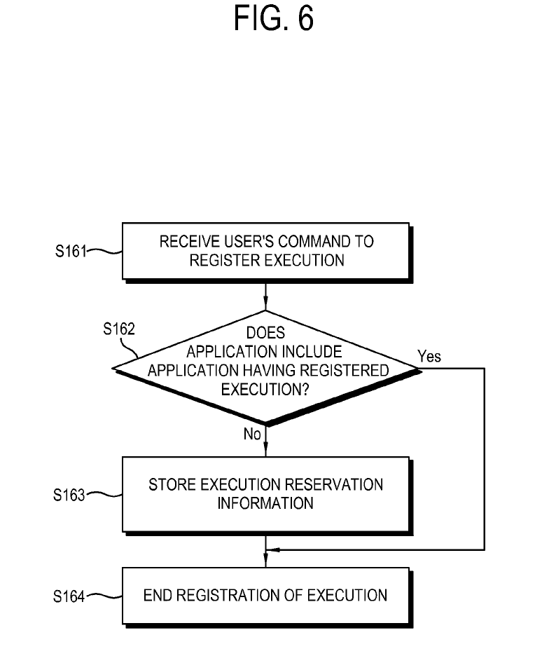

As shown in FIG. 6, the controller 170 may receive a user's command to register the execution of the application (S161).

The registered execution refers to a registration of the application to be automatically executed so that a user views the broadcasting program corresponding to the application. The broadcasting program may include series programs which are broadcast on the particular time on a particular day. If the execution is registered, a channel is automatically changed to the broadcasting channel of the broadcasting program at the registered execution time.

At operation S161, the user's command to register the execution is inputted by a particular button of the user input unit 140, and may be independently inputted from a user's command to bookmark the application.

The controller 170 compares the broadcasting program information of the application having the registered execution at operation S161 with the broadcasting program information stored in the storage unit 150, and determines whether the application is the application having the registered execution (S162).

If the application is not the application having the registered execution at operation S162, the controller 170 stores the execution reservation information of the application in the storage unit 150 (S163), and the registration of the execution ends (S164).

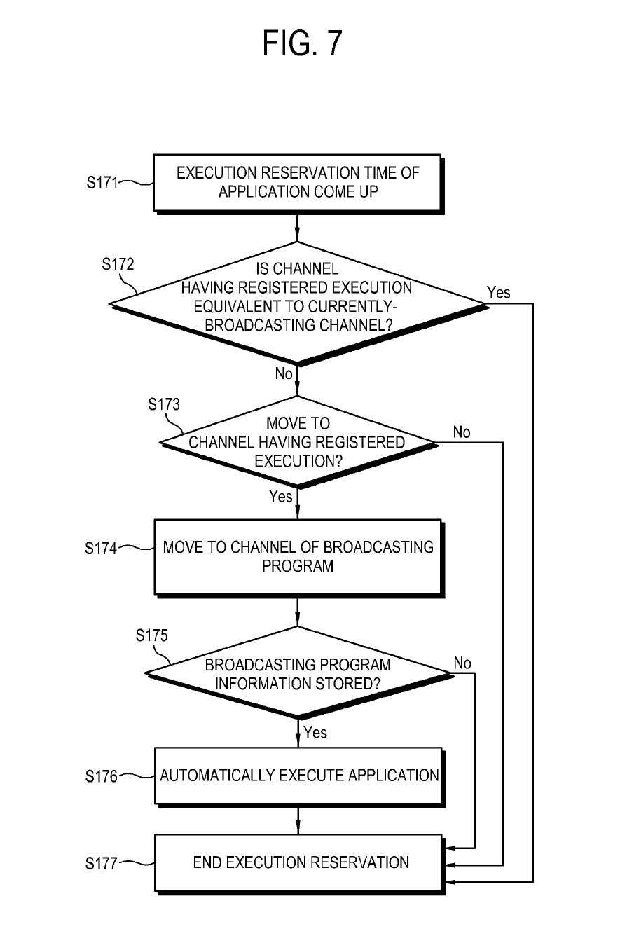

As shown in FIG. 7, the controller 170 monitors whether the execution reservation time of the application having the registered execution comes up (S171).

If the reservation time comes up at operation S171, the controller 170 determines whether the channel of the broadcasting program having the registered execution is equivalent to the currently-broadcast channel (S172).

If the channels are not equivalent to each other at operation S172, the controller 170 controls the UI generator 160 to generate a UI of changing a channel to the channel registered for the execution and outputs the UI to the display unit 132, and receives a command from a user (S173).

The controller 170 changes to the broadcasting program channel corresponding to the application having the registered execution according to a user's selection at operation S173, and provides the broadcasting program to a user through the output unit 130 (S174).

The controller 170 determines whether the application is the application having the bookmarked, i.e. stored broadcasting program information (S175).

If it is determined at operation S175 that the application is the bookmarked application, the controller 170 automatically executes the application to provide a user with the broadcasting program information (S176), and the execution reservation ends (S177).

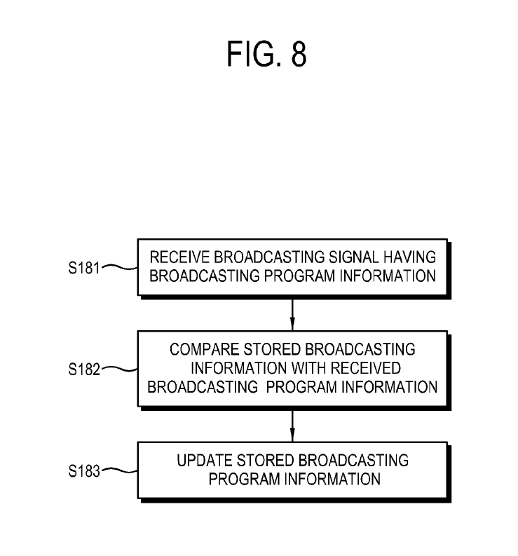

As shown in FIG. 8, the controller 170 may continuously receive the bookmarked application through the signal receiver 110 (S181).

The controller 170 compares the broadcasting program information included in the application received at operation S181, with the broadcasting program information stored in the storage unit 150 (S182).

The controller 170 may update the broadcasting program information stored in the storage unit 150 with the latest information, based on the comparison result obtained at operation S182 (S183).

The controller 170 may update the broadcasting program information with the latest information or maintain the existing information according to user's selection. Even if the broadcasting program information is updated, the existing information may be stored in the storage unit 150 to be searched by a user at any time.

As described above, an aspect of the present invention provides a broadcasting signal processing apparatus which stores broadcasting program information corresponding to an application that was executed before, to be searched by a user at any time, and a control method thereof.

Also, an aspect of the present invention provides a broadcasting signal processing apparatus which provides a list of stored applications so that a user searches desired broadcasting program information without difficulty, and a control method thereof.

Further, an aspect of the present invention provides a broadcasting signal processing apparatus which adds information on execution reservation to stored broadcasting program information, to provide the broadcasting program if the broadcasting time of the desired broadcasting program comes up, and a control method thereof.

Further, an aspect of the present invention provides a broadcasting signal processing apparatus which frequently updates stored broadcasting program information to be prepared for changes such as a change in a broadcasting time of a program, and a control method thereof.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcasting signal processing apparatus, comprising:
a signal processor which processes a broadcasting signal having an application to provide broadcasting program information;
an output unit which outputs the broadcasting program information; and
a controller which stores the broadcasting program information of the application according to a user's command, and provides the broadcasting program information corresponding to the selected application through the output unit if the stored application is selected by a user.

2. The broadcasting signal processing apparatus according to claim 1, wherein the broadcasting program information comprises at least one of a title of the application, a storage date, channel information, broadcasting information, broadcasting time, a synopsis, characters and a thumb image of the broadcasting program.

3. The broadcasting signal processing apparatus according to claim 1, wherein the controller stores the broadcasting program information corresponding to the executed application if a user inputs a particular command while the application is executed.

4. The broadcasting signal processing apparatus according to claim 1, wherein the controller stores a plurality of applications and controls the output unit to display a list of the stored applications.

5. The broadcasting signal processing apparatus according to claim 2, wherein the broadcasting program information further comprises execution reservation information of the application and the broadcasting program corresponding to the application.

6. The broadcasting signal processing apparatus according to claim 5, wherein the controller outputs the application and the broadcasting program corresponding to the application at a reservation time corresponding to the stored execution reservation information.

7. The broadcasting signal processing apparatus according to claim 1, further comprising a user input unit which receives a user's command.

8. The broadcasting signal processing apparatus according to claim 1, further comprising a storage unit which stores the broadcasting program information therein.

9. The broadcasting signal processing apparatus according to claim 1, wherein the output unit comprises a display unit.

10. The broadcasting signal processing apparatus according to claim 1, further comprising a user interface (UT) generator which generates at least one UT having a menu on the broadcasting program information.

11. The broadcasting signal processing apparatus according to claim 1, further comprising a broadcasting receiver which receives the broadcasting signal having the application.

12. The broadcasting signal processing apparatus according to claim 11, wherein the controller compares the stored broadcasting program information with broadcasting program information received through the broadcasting receiver, and updates the stored broadcasting program information based on the comparison result.

13. A broadcasting signal processing apparatus, comprising:
a signal processor which processes a broadcasting signal having an application to provide broadcasting program information;
an output unit which outputs the broadcasting program information; and
a controller which receives a user's command to reserve an execution of the application, and provides the broadcasting program information corresponding at the application on a reservation time through the output unit.

14. The broadcasting signal processing apparatus according to claim 13, further comprising a storage unit, wherein
the controller stores the inputted execution reservation information in the storage unit.

15. The broadcasting signal processing apparatus according to claim 13, wherein the controller outputs a broadcasting program corresponding to the application at the reservation time.

16. A control method of a broadcasting signal processing apparatus, comprising:
executing an application to provide broadcasting program information;
storing broadcasting program information of the application according to a user's command; and
providing the broadcasting program information corresponding to the selected application if the stored application is selected by a user.

17. The control method according to claim 16, wherein the broadcasting program information comprises at least one of a title of the application, a storage date, channel information, broadcasting information, broadcasting time, a synopsis, characters, and a thumb image of the broadcasting program.

18. The control method according to claim 16, wherein the storing the program information stores program information of a plurality of applications and further comprising displaying a list of the stored applications before providing the broadcasting program information.

19. The control method according to claim 17, wherein the broadcasting program information further comprises execution reservation information of the application and the broadcasting program corresponding to the application.

20. The control method according to claim 19, further comprising changing to a channel providing a broadcasting program corresponding to the application at a reservation time corresponding to the stored execution reservation information, and executing the application.

21. The control method according to claim 16, wherein the storing the program information stores program information of a plurality of applications and further comprising generating at least one menu having a list of the applications having the stored broadcasting program information.

22. The control method according to claim 16, further comprising receiving a broadcasting signal having the application having the stored broadcasting program information; and
comparing the stored broadcasting program information with broadcasting program information included in the received broadcasting signal, and updating the stored broadcasting program information based on the comparison result.

23. A control method of a broadcasting signal processing apparatus, comprising:
executing an application to provide broadcasting program information;
receiving a user's command to reserve an execution of the application; and
providing broadcasting program information corresponding to the application at a reservation time.

24. The control method according to claim 23, further comprising storing information on the inputted execution reservation.

25. The control method according to claim 23, wherein the providing the broadcasting program information comprises outputting a broadcasting program corresponding to the application at the reservation time.
